(19) United States
(12) Patent Application Publication
(10) Pub. No.: US 2012/0173007 A1
(43) Pub. Date: Jul. 5, 2012

(54) AUDIO PLAYER, AUDIO PLAYER SYSTEM, AND METHOD FOR TURNING OFF AUDIO PLAYER

(75) Inventors: BIN LIU, Shenzhen City (CN); WEN-WU WANG, Shenzhen City (CN); WEN-DONG LUO, Shenzhen City (CN); TSUNG-JEN CHUANG, Tu-Cheng (TW); SHIH-FANG WONG, Tu-Cheng (TW)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/109,003

(22) Filed: May 17, 2011

(30) Foreign Application Priority Data
Dec. 31, 2010 (CN) 201010619602.7

(51) Int. Cl. G06F 17/00

(52) U.S. Cl. 700/94

(57) ABSTRACT

An audio player includes a control module and an audio interface, wherein the audio interface includes a microphone pin, a ground pin respectively connected to corresponding pins of an earphone when the earphone is connected to the player through the audio interface. The control module is used for detecting a change in a resistance value between the microphone pin and the ground pin, and powers off the audio player when detecting the earphone is entered into an idle state according to the detected change in the resistance value that is a change from a first resistance value to a second resistance value. The present disclosure also provides an audio player system using the audio player, and a method.

### BACKGROUND

1. Technical Field

The present disclosure relates to audio players, and particularly, to an audio player capable of automatically powering itself off, an audio player system using the audio player, and a method thereof.

2. Description of Related Art

An audio player can be powered off in response to user operations on a power button of the audio player or a power button of an earphone connected to the audio player. However, the audio player cannot automatically power itself off when the audio player is in an idle state, which may lead to waste of power.

### BRIEF DESCRIPTION OF THE DRAWINGS

Many aspects of the present disclosure should be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a block diagram of an audio player system in accordance with an exemplary embodiment.

FIG. 2 is a schematic view of the audio player system of FIG. 1 in accordance with an exemplary embodiment.

FIGS. 3A-3B are schematic views showing a resistor unit of the audio player system of FIG. 1 in an upright state and a horizontal state in accordance with an exemplary embodiment.

FIG. 4 is a flowchart of a method for turning off an audio player automatically in accordance with an exemplary embodiment.

### DETAILED DESCRIPTION

Embodiments of the present disclosure will now be described in detail below, with reference to the accompanying drawings.

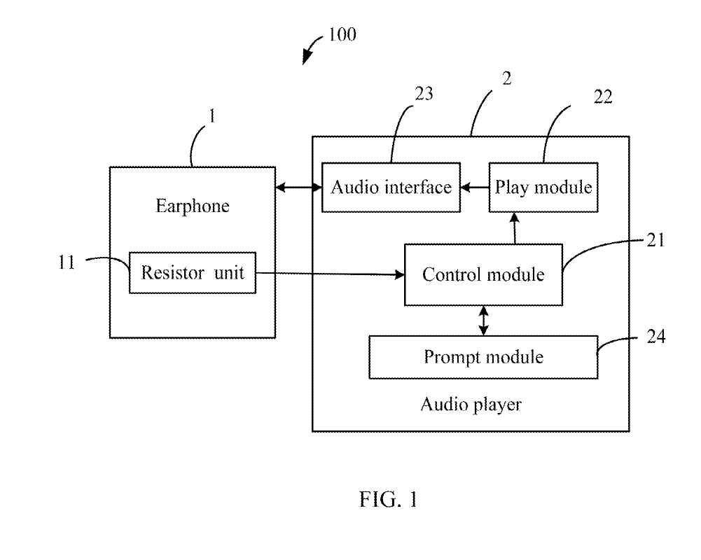

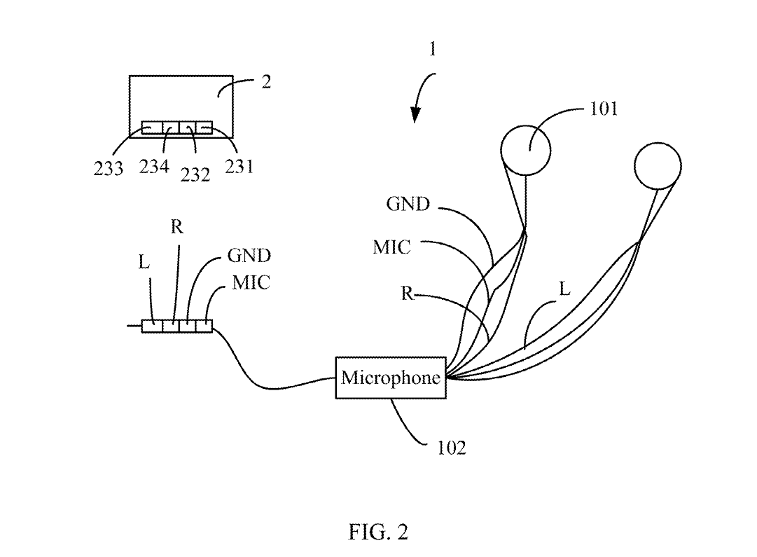

Referring to FIGS. 1-2, an audio player system 100 includes an earphone 1 and an audio player 2. The earphone 1 includes two earpieces 101, a microphone 102, a microphone line MIC, a ground line GND, a left channel line L, and a right channel line R. The microphone 102 is connected between the microphone line MIC and the ground line GND. The audio player 2 includes a control module 21, a play module 22, and an audio interface 23. The audio player 2 is connected to the earphone 1 via the audio interface 23. The audio interface 23 includes a microphone pin 231, a ground pin 232, a left channel pin 233, and a right channel pin 234 respectively connected to the corresponding pins of the earphone 1 when the earphone 1 is connected to the audio player 1. The control module 21 is configured for controlling the play module 22 to play audio/video files stored in the player 2. The control module 21 is further configured for detecting a change in a resistance value between the microphone pin 231 and the ground pin 232, and determining whether to power off the audio player 2 according to the detected change in the resistance value.

In a first embodiment, the earphone 1 is a standard earphone, and when the earphone 1 is connected to the audio player 2, the resistance value between the microphone pin 231 and the ground pin 232 is the resistance value of the microphone 102, and when the earphone 1 is pulled out of the audio player 2, the resistance value between the microphone pin 231 and the ground pin 232 is infinite. In the first embodiment, when the control module 21 determines that the resistance value between the microphone pin 231 and the ground pin 232 is changed from the resistance value of the microphone 102 to the infinite, the control module 21 determines that the audio player 2 may enter into an idle state and thus powers off the audio player 1 to conserve power.

In a second embodiment, the earphone 1 is designed to have different resistance value when the earphone 1 is in different state. In the second embodiment, when the earphone 1 is in a first state such as an upright state, the earphone 1 has a first resistance value, and when in a second state such as a horizontal state, the earphone 1 has a second resistance value. Furthermore, when the earphone 1 is connected to the audio player 2 and is in the upright state, the resistance value between the microphone pin 231 and the ground pin 232 is the first resistance value, and in the horizontal state, the resistance value between the microphone pin 231 and the ground pin 232 is the second resistance value. The audio player 2 powers itself off when the audio player 2 determines that the resistance value between the microphone pin 231 and the ground pin 232 is changed from the first resistance value to the second resistance value. The detail structure of the earphone 2 will be described below.

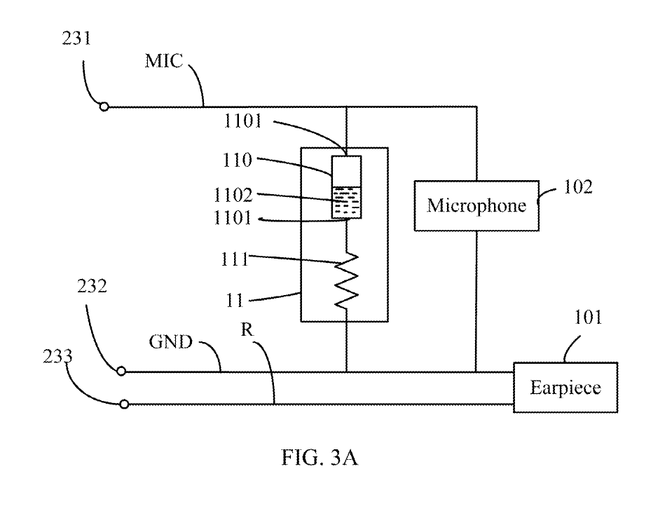

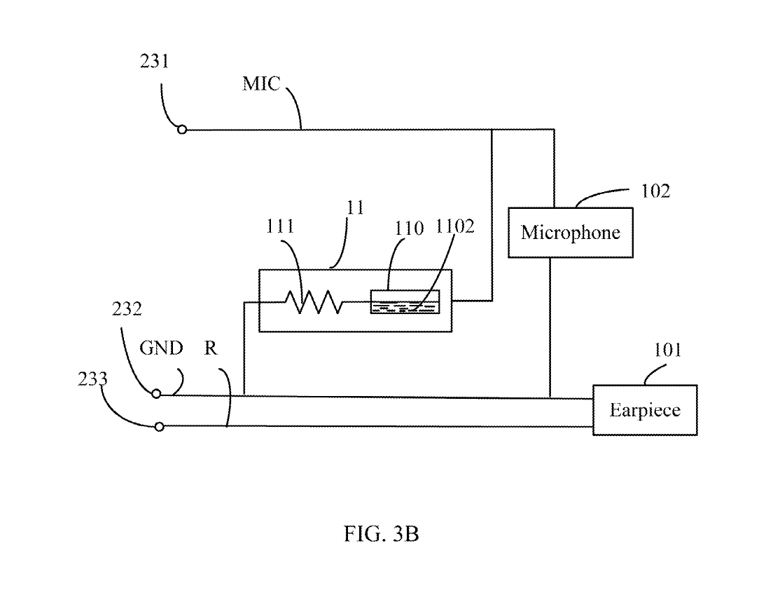

Referring to FIGS. 3A-3B, in the second embodiment, the earphone 1 further includes a resistor unit 11 connected to the microphone 102 in parallel between the grounded line GND and the microphone line MIC. In this embodiment, the resistor unit 11 is arranged in the earpiece 101. The resistor unit 11 includes a hollow and closed container 110 and a resistor 111 connected in serial between the grounded line GND and the microphone line MIC. The container 110 includes two conductive ends 1101 respectively connected to the microphone line MIC and the resistor 111. The rest of the container 110 is insulative. The container 110 includes conductive liquid 1102 therein and the conductive liquid 1102 fills a portion of the container 110. In this embodiment, the conductive liquid 1102 is mercury.

When the earphone 1 is connected to the player 2 and in the upright state, the conductive liquid 1102 only contacts one of the conductive ends 1101 due to gravity. Thus, the resistor unit 11 is in an open state and the resistance value between the microphone line MIC and the ground line GND is only the resistance value of the microphone 102, that is the first resistance value. When the earphone 1 is in the horizontal state, shown as FIG. 3B, the conductive liquid 1102 connects both of the two conductive ends 1101, thus the resistor unit 11 is conductive and connected to the microphone 101 in parallel between the microphone line MIC and the ground line GND. The resistance value between the microphone pin 231 and the ground pin 232 is changed to the second resistance value.

The audio player 2 may further include a prompt module 24 to generate information within a preset period to prompt users to power off the audio player 2 when the control module 21 determines that the audio player 2 is idle. If the control module 21 does not receive input corresponding to the prompt information within the preset period, the control module 21 powers off the audio player 2. If receiving input corresponding to the prompt information within the preset period, the control module 21 does not power off the audio player 2.

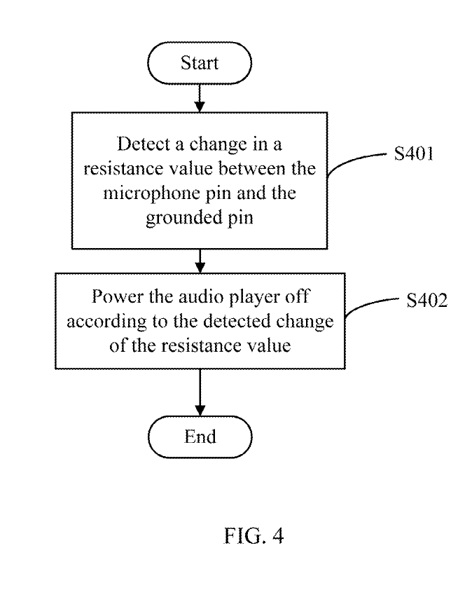

FIG. 4 is a flowchart of a method for powering off the audio player 2 automatically in accordance with an exemplary embodiment.

In step S401, the control module 21 detects a change in the resistance value between the microphone pin 231 and the ground pin 232.

In step S402, the control module 21 powers off the audio player 2 when the control module 21 determines the detected change in the resistance value is a change from a first resistance value to a second resistance value. In the first embodiment, the first resistance value is the resistance value of the microphone 102, and the second resistance value is infinite. In the second embodiment, the first resistance value is the resistance value of the microphone 102, and the second resistance value is the parallel resistance value of the resistor unit 11 and the microphone 102.

In an alternative embodiment, before executing step S402, the control module 21 directs the prompt module 24 to generate information within a preset period to prompt users to power off the audio player 2 when the control module 21 detects the detected change in the resistance value is a change from a first resistance value to a second resistance value. If the control module 21 receives input corresponding to the prompt information within the preset period, the audio player 2 remains powered on. If input corresponding to the prompt information is not received within a preset period, the control module 21 powers off the audio player 2.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. An audio player comprising:
an audio interface comprising a microphone pin and a ground pin respectively connected to corresponding pins of an earphone; and
an control module to detect a change in a resistance value between the microphone pin and the ground pin, and determine whether to power off the audio player according to the detected change in the resistance value.

2. The audio player as described in claim 1, wherein the control module powers off the audio player when the detected resistance value is changed from a first resistance value to a second resistance value, the first resistance value is a resistance value of a microphone of the earphone connected to the audio player, and the second resistance value is infinite.

3. The audio player as described in claim 1, wherein the control module powers off the audio player when the detected resistance value is changed from a first resistance value to a second resistance value, the first resistance value is a resistance value of a microphone of the earphone connected to the audio player, and the second resistance value is a parallel resistance value of a resistor unit and a microphone of the earphone connected to the audio player.

4. The audio player as described in claim 1, further comprising a prompt module to generate prompt information within a preset period to prompt users whether to power off the audio player when the control module determines to power off the audio player.

5. The audio player as described in claim 4, wherein the control module is to power off the audio player if not receiving input corresponding to the prompt information within the preset period, and does not power off the audio player if receiving input corresponding to the prompt information within the preset period.

6. An audio player system comprising:
an earphone having different resistance value when the earphone is in different state, wherein when the earphone is in a first state, the earphone has a first resistance value, and when in a second state, the earphone has a second resistance value; and
an audio player comprising an audio interface and a control module, wherein the audio interface comprises a microphone pin and a ground pin respectively connected to corresponding pins of the earphone, the control module is to detect a change in a resistance value between the microphone pin and the ground pin, and powers off the audio player when the control module determines that the resistance value between the microphone pin and the ground pin is changed from the first resistance value to the second resistance value.

7. The audio player system as described in claim 6, wherein the earphone further comprises a microphone and a resistor unit connected to the microphone in parallel between the ground line and the microphone line, the first resistance value is the resistance value of the microphone, and the second resistance value is a parallel resistance value of the resistor unit and the microphone.

8. The audio player system as described in claim 7, wherein the resistor unit comprises a hollow and closed container and a resistor connected in serial, the container comprises two conductive ends respectively connected to the microphone line and the resistor, the rest of the container is insulative, the container comprises conductive liquid therein and the conductive liquid takes a portion of the container, when the earphone is in the first state, the conductive liquid only contacts one of the conductive ends, the resistor unit is in an open state and the resistance value between the microphone line and the ground is the first resistance value, when the earphone is in the second state, the conductive liquid contacts both of the two conductive ends, the resistor unit is conductive and the resistance value between the microphone line and the ground line is the second resistance value.

9. The audio player system as described in claim 7, wherein the resistor unit is arranged in an earpiece of the earphone.

10. The audio player system as described in claim 8, wherein the conductive liquid is mercury.

11. The audio player system described as claim 6 wherein the audio player further comprises a prompt module to generate prompt information within a preset period to prompt users whether to power off the audio player when the control module determines that the detected resistance value is changed from the first resistance value to the second resistance value.

12. The audio player system as described in claim 11, wherein the control module is to power off the audio player if not receiving input corresponding to the prompt information within the preset period, and remains power on the audio player if receiving input corresponding to the prompt information within the preset period.

13. A method for turning off an audio player automatically, the audio player comprising an audio interface, the audio interface comprising a microphone pin and a ground pin respectively connected to corresponding pins of an earphone, the method comprising:
detecting a change in a resistance value between the microphone pin and the ground pin of the audio interface; and
powering off the audio player according to the detected change in the resistance value.

14. The method as described in claim 13, wherein the method of powering off the audio player according to the detected change in the resistance value comprising:
powering off the audio player when the detected change in the resistance value is a change from a first resistance value to a second resistance value, wherein the first resistance value is a resistance value of a microphone of the earphone connected to the audio player, and the second resistance value is infinite.

15. The method as described in claim 13, wherein the method of powering off the audio player according to the detected change in the resistance value comprising:
powering off the audio player when the detected change in the resistance value is a change from a first resistance value to a second resistance value, wherein the first resistance value is a resistance value of a microphone of the earphone connected to the audio player, and the second resistance value is a parallel resistance value of a resistor unit and a microphone of the earphone connected to the audio player.

16. The method as described in claim 13, further comprising:
generating a prompt information within a preset period to prompt users whether to power off the audio player when the control module determines to power off the audio player;
powering off the audio player if not receiving user input to respond the prompt information within the preset period; and
remaining power on the audio player if receiving input corresponding to the prompt information within the preset period.
